(19) United States
(12) Patent Application Publication
(10) Pub. No.: US 2022/0101281 A1
(43) Pub. Date: Mar. 31, 2022

(54) CHECK CLEARING SYSTEM AND METHOD

(71) Applicant: Sivam RAJOO, Puchong, Selangor (MY)

(72) Inventor: Rajasuriya LECHIMANAN, Puchong, Selangor (MY)

(73) Assignee: Sivam RAJOO, Puchong, Selangor (MY)

(21) Appl. No.: 17/420,984

(22) PCT Filed: Jan. 8, 2020
(86) PCT No.: PCT/MY2020/050002

§ 371 Date: Jul. 6, 2021

(30) Foreign Application Priority Data
Jan. 8, 2019 (MY) PI 2019000280

(51) Int. Cl. G06Q 20/02; G06Q 20/04; G06Q 20/32; G06Q 20/40; G06Q 40/02

(52) U.S. Cl. CPC G06Q 20/023; G06Q 20/042; G06Q 40/02; G06Q 20/407; G06Q 20/3276

(57) ABSTRACT

A cheque clearing system (102) for enabling customers of a bank to issue digital cheques from bank server (108) using their computer (105), and for enabling beneficiary of cheques to deposit the digital cheques using their mobile phones (104) is provided herein. The cheque clearing system (102) includes a digital cheque module (202) configured to enable a customer of a bank to issue a digital cheque from a bank server (108) using the computer (105). The cheque clearing system (102) further includes a deposit module (204) configured to enable a beneficiary of the cheque to deposit the digital cheque using his/her mobile phone (104). The cheque clearing system (102) further includes a processing module (206) configured to receive the digital cheque from the beneficiary mobile phone (104), and process the digital cheque to retrieve information about the cheque. The cheque clearing system (102) further includes a credit module (210) configured to credit amount of the digital cheque in beneficiary account, based on the processing and successful verification.

### FIELD OF THE INVENTION

Embodiments of the present invention, generally relate to banking, and in particular relate to cheque clearing process.

### BACKGROUND

Currently, banks require approximately two to three working days to process a cheque and transfer the funds accordingly. Most of the banks operates on semi computerized (partly manual & partly system) environment to process the cheque, as shown in prior art of FIG. 1. Once the cheque beneficiary receives the cheque, the cheque is required to be deposited via a cheque deposit machine (CDM). Next, the bank branch personnel may collect all the cheques that were deposited in the CDM, and may record total number of cheques before sending it to in-house or outsourced cheque clearing house or service provider.

Next, the cheque processing may take place e.g. cheque scanning, conversation, revalidation and data entry. Once the cheque is processed, the data may be transferred to the server, whereby it is accessible by the cheque issuing bank. Further, if it cash cheque, house cheque or inter-branch cheque, the transaction may be completed within the Issuing bank and the account will be debited and credited accordingly. However, if the cheque is inter-bank cheque, the cheque or data may be sent to central cheque clearing house for verification from the cheque issuing bank. Once the cheque is verified by issuing bank, the cheque may be sent back to the cheque clearing house, and this data or image may be forwarded to cheque receiving bank to complete the transaction accordingly.

However, above described conventional cheque processing scenario suffers from several disadvantages. First, the bank typically faces many issues and challenges, such as high cost of cheque processing. Further, payment is not credited on time in these conventional cheque clearing processes, as it takes long time to clear the cheque. Further, the conventional cheque clearing processes lack sufficient security arrangements, as even fraudulent cheques are cleared for payment.

Therefore, there is a need for an improved system and method for cheque clearing process which solves above disadvantages associated with the conventional methods.

### SUMMARY

According to an aspect of the present disclosure, a cheque clearing system (102) for enabling customers of a bank to issue digital cheques from bank server (108) using their computer (105), and for enabling beneficiary of cheques to deposit the digital cheques using their mobile phones (104) is provided herein. The cheque clearing system (102) includes a digital cheque module (202) configured to enable a customer of a bank to issue or print a digital cheque from a bank server (108) using the computer (105). The cheque clearing system (102) further includes a deposit module (204) configured to enable a beneficiary of the cheque to deposit the digital cheque using his/her mobile phone (104). The cheque clearing system (102) further includes a processing module (206) configured to receive the digital cheque from the beneficiary mobile phone (104), and process the digital cheque to retrieve information about the cheque. The cheque clearing system (102) further includes a credit module (210) configured to credit amount of the digital cheque in beneficiary account, based on the processing and successful verification.

According to another aspect of the present disclosure, a computer-implemented method for enabling customers of a bank to issue digital cheques from bank server (108) using their computer (105), and for enabling beneficiary of cheques to deposit the digital cheques using their mobile phones (104) is provided herein. The computer-implemented method includes enabling a customer of a bank to issue a digital cheque from a bank server (108) using the computer (105). The computer-implemented method further includes enabling a beneficiary of the cheque to deposit the cheque using his/her mobile phone (104). The computer-implemented method further includes receiving the digital cheque from a beneficiary mobile phone (104), and processing the digital cheque to retrieve information. The computer-implemented method further includes verifying the retrieved information from the digital cheque with information stored on the bank server (108), and crediting amount of the digital cheque in beneficiary account based on the processing and successful verification.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 is an overview of manual cheque processing flow of prior art, according to an embodiment of the present invention;

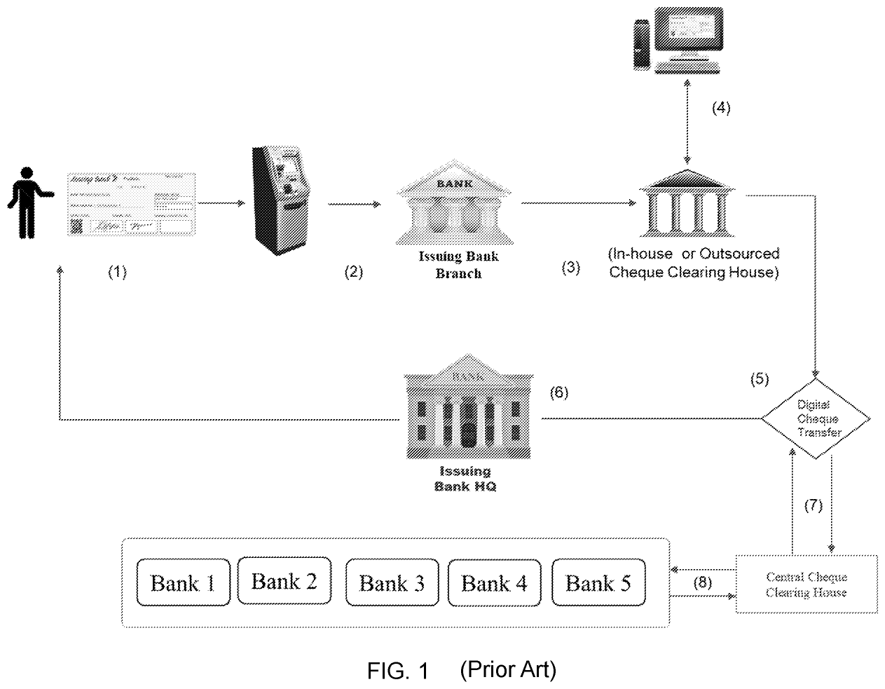

FIG. 2 is a block diagram depicting a network environment according to an embodiment of the present invention;

FIG. 3 is a block diagram of modules stored in memory, according to an embodiment of the present invention;

FIG. 4 illustrates login via banks web portal/banks financial portal/online banking, according to an embodiment of the present invention;

FIG. 5 illustrates homepage of the customer account with the bank having facility to print the cheque, according to an embodiment of the present invention;

FIG. 6 illustrates required information to issue digital cheque by the customer on homepage of the customer account with the bank, according to an embodiment of the present invention;

FIG. 7 illustrates an exemplary cheque printed from blank paper, according to an embodiment of the present invention;

FIG. 8 illustrates disposition of the cheque via mobile phone by the beneficiary of the cheque, according to an embodiment of the present invention;

FIG. 9 illustrates essential components for cheque clearing compliance, according to an embodiment of the present invention;

FIG. 10 illustrates process flow for printing any type of cheque on blank paper, depositing via mobile phone and processing the cheque via central cheque clearing house, according to an embodiment of the present invention;

FIG. 11 illustrates process flow for printing any type of cheque on blank paper, depositing via mobile phone and processing the cheque via cheque issuing banks in-house cheque clearing system, whereby cash cheque, house cheque and inter-branch cheque may be cleared within the bank whereas for inter-bank cheque may be cleared via IBG transaction according to an embodiment of the present invention; and

FIG. 12 illustrates process flow for depositing and cheque clearing process of a digital cheque via mobile phone, according to an embodiment of the present invention.

To facilitate understanding, like reference numerals have been used, where possible, to designate like elements common to the figures.

### DETAILED DESCRIPTION

As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or an), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

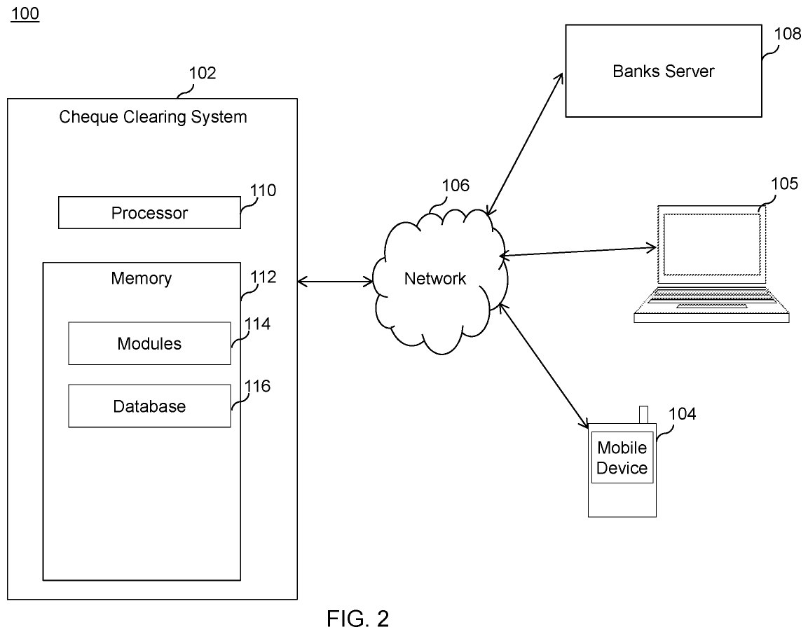

FIG. 2 illustrates an exemplary network environment (100) where various embodiments of the present invention may be implemented. The network environment (100) includes a cheque clearing system (102) connected to various electronic devices such as smart phone/mobile phone (104) and a desktop computer/laptop (105) via a network (106). In an embodiment, the cheque clearing system (102) may be hosted internal to a bank data center or external to bank data center. Further, the Network (106) may include, but is not restricted to, a communication network such as Internet, PSTN, Local Area Network (LAN), Wide Area Network (WAN), Metropolitan Area Network (MAN), and so forth. In an embodiment, the network (106) can be a data network such as the Internet. Further, the messages exchanged between the cheque clearing system (102), the computer (105), the bank server (108), and the mobile devices (104) can comprise any suitable message format and protocol capable of communicating the information necessary for the cheque clearing system (102) to enable customers of a bank to issue digital cheques from a bank server (108) using their computers (105), and for enabling beneficiary of cheques to deposit the digital cheques using their mobile phones (104). The mobile devices (104) may utilize the cheque clearing system (102) to enable beneficiary of cheques to deposit the digital cheques using their mobile phones (104).

In an embodiment of the present invention, the cheque clearing system (102) may be a computing device. In operation, a user of the computer (105) may access the cheque clearing system (102) to issue a digital cheque from the bank server (108) using the cheque clearing system (102), and a user of the mobile device (104) may access the cheque clearing system (102) to deposit his/her digital cheque to the bank server (108) using the cheque clearing system (102). The cheque clearing system (102) includes a processor (110) and a memory (112). In one embodiment, the processor (110) includes a single processor and resides at the cheque clearing system (102). In another embodiment, the processor (110) may include multiple sub-processors and may reside at the cheque clearing system as well as the mobile device.

Further, the memory (112) includes one or more instructions that may be executed by the processor (110) to enable a customer of a bank to issue and print a digital cheque from a bank server (108), to enable a beneficiary of the cheque to deposit the cheque using his/her mobile phone (104), to receive the digital cheque from a beneficiary mobile phone (104), and process the digital cheque to retrieve information, and to credit amount of the digital cheque in beneficiary account based on the successful verification.

In one embodiment, the memory (112) includes the modules (114), a database (116), and other data (not shown in figure). The other data may include various data generated during processing of the digital cheques having signature and quick response (QR) code. In one embodiment, the database (116) is stored internal to the cheque clearing system (102). In another embodiment, the database (116) may be stored external or internal to the cheque clearing system (102), and may be accessed via the network (106). Furthermore, the memory (112) of the cheque clearing system (102) is coupled to the processor (110).

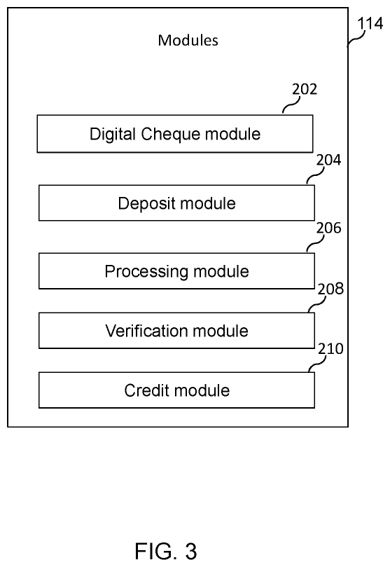

Referring to FIG. 3, the modules (114) includes a digital cheque module (202), a deposit module (204), a processing module (206), a verification module (208), and a credit module (210). The modules (114) are instructions stored in the memory and may process the received digital cheques from mobile phone (104) to facilitate clearing of the digital cheques.

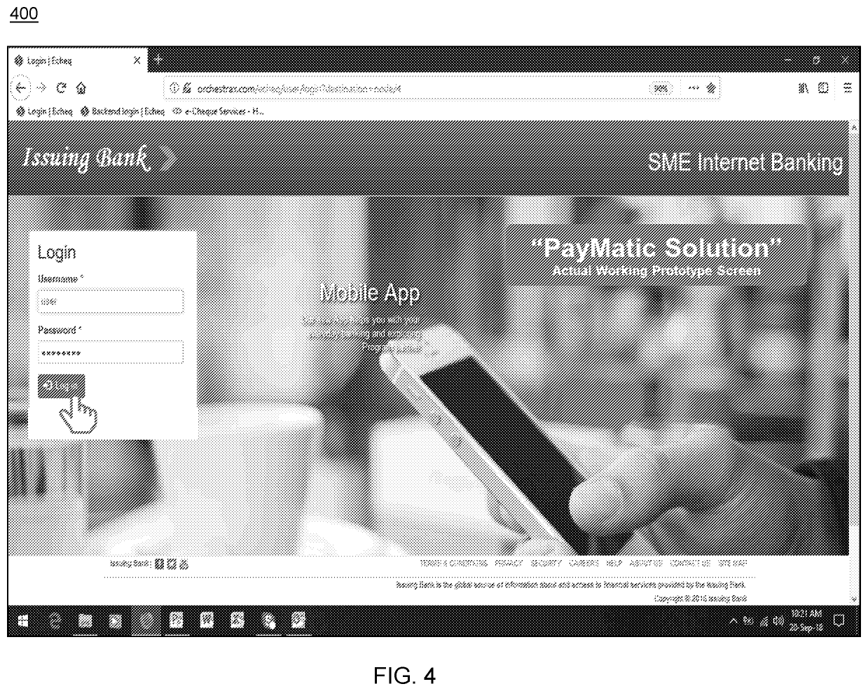

According to an embodiment of the present invention, the digital cheque module (202) is configured to enable a customer of a bank to issue a digital cheque from a bank server (108) using his/her personal computer (105). In an embodiment, the customer of a bank may login on a bank's portal using his/her login credentials such as customer ID and password, as shown in FIG. 4. Those skilled in the art will appreciate that bank server (108) will be different for different banks, and the customer of the bank has to provide login details corresponding to the bank. Further, the cheque clearing system (102) is connected with the bank server (108) of a plurality of banks via the network (106).

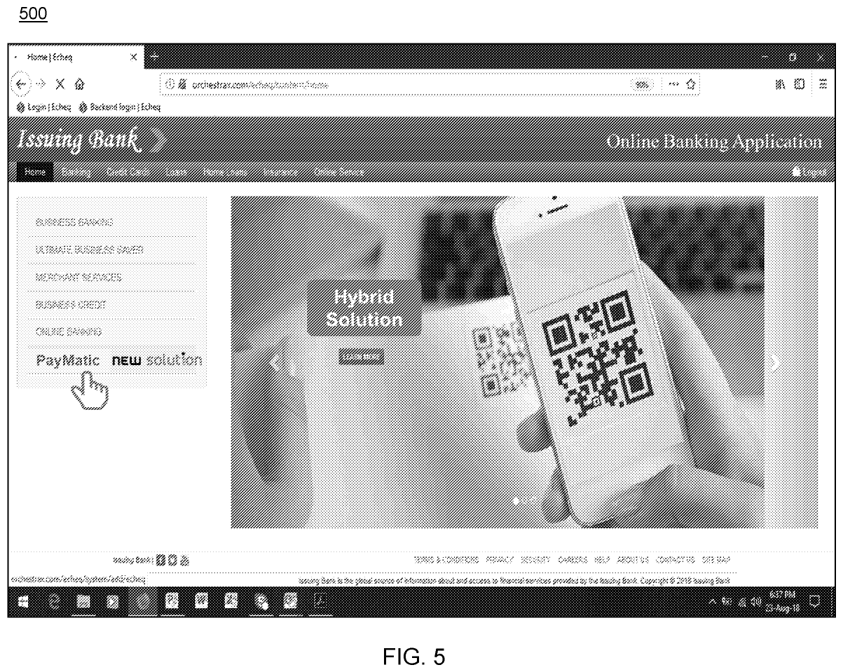

Based on successful login details provided by the customer, the customer of the bank may be directed on home page of the bank's portal/website, as shown in FIG. 5. In an embodiment, the digital cheque module (202) is further configured to provide the customer of the bank an option (such as Paymatic link) on the home page of the bank website (as shown in FIG. 4) as well as home page of the customer account (as shown in FIG. 5) to order a digital cheque from his/her account with the bank. Further, the bank server (108) may record order transaction performed by the customer of the bank on the bank portal and other details of the issued digital cheque.

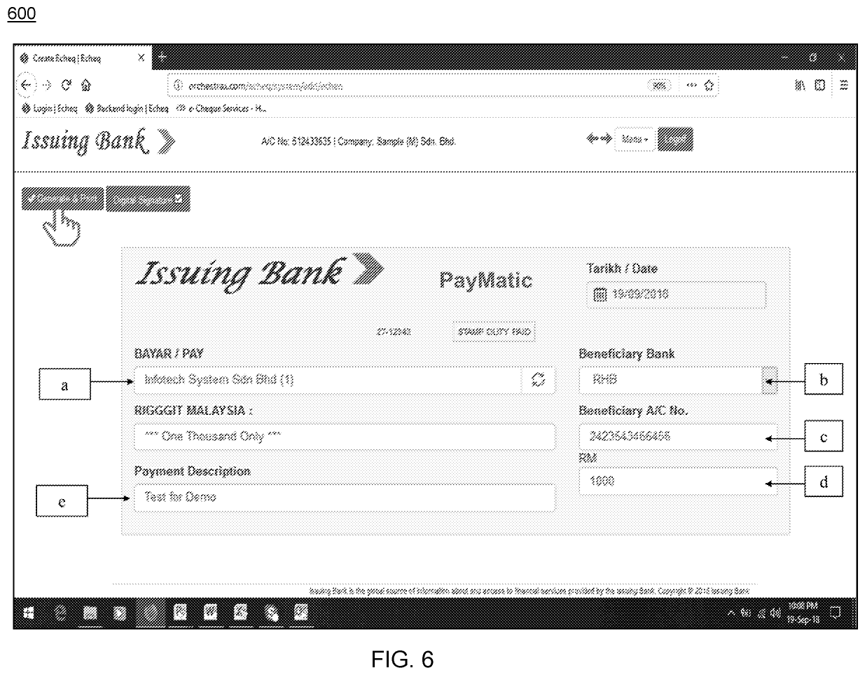

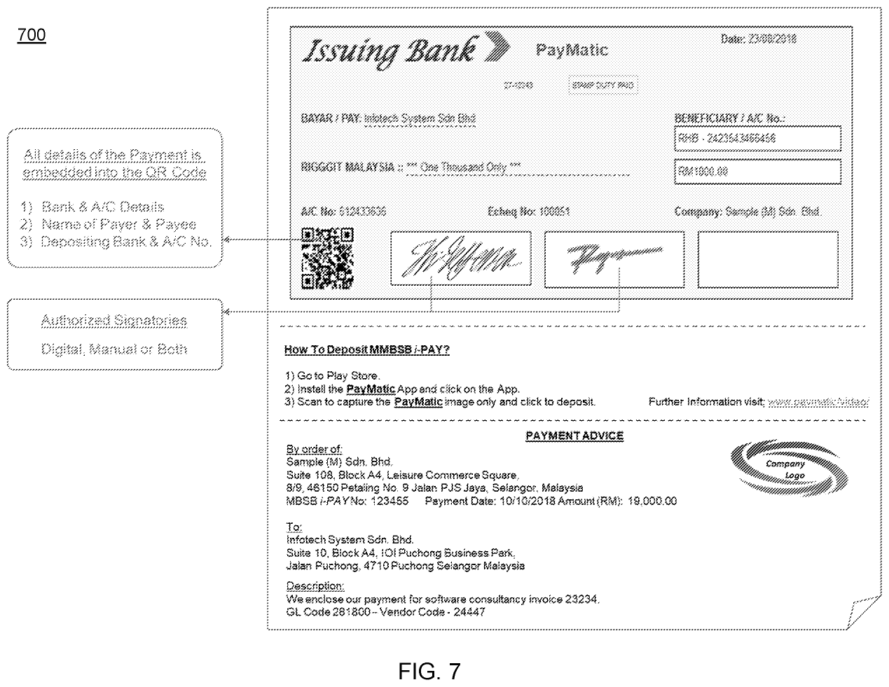

In an embodiment, as shown in FIG. 6, the digital cheque may include various information such as beneficiary name, beneficiary bank, beneficiary a/c no., date, amount, signature, and payment description. The digital cheque module (202) is further configured to enable the customer of the bank to issue print command to print the digital cheque on a blank paper using a printer connected to his/her personal computer (105). In an embodiment, the printed cheque may contain various information including beneficiary name, beneficiary bank, beneficiary a/c no., date, amount, signature, and payment description, as shown in FIG. 7.

Further, according to an embodiment of the present invention, as shown in FIG. 7, the printed digital cheque may also include a quick response code (QR code). Those skilled in the art will appreciate that QR code (quick response code) is a type of two-dimensional bar code that is used to provide easy access to information through a smartphone. In an embodiment, all the digital cheque information may be converted, embedded or stored in the QR Code. In another embodiment, any other type of code (different than QR code) may also be used that can store all digital cheque information. The printed cheque may be given by the customer of the bank to a beneficiary of the cheque.

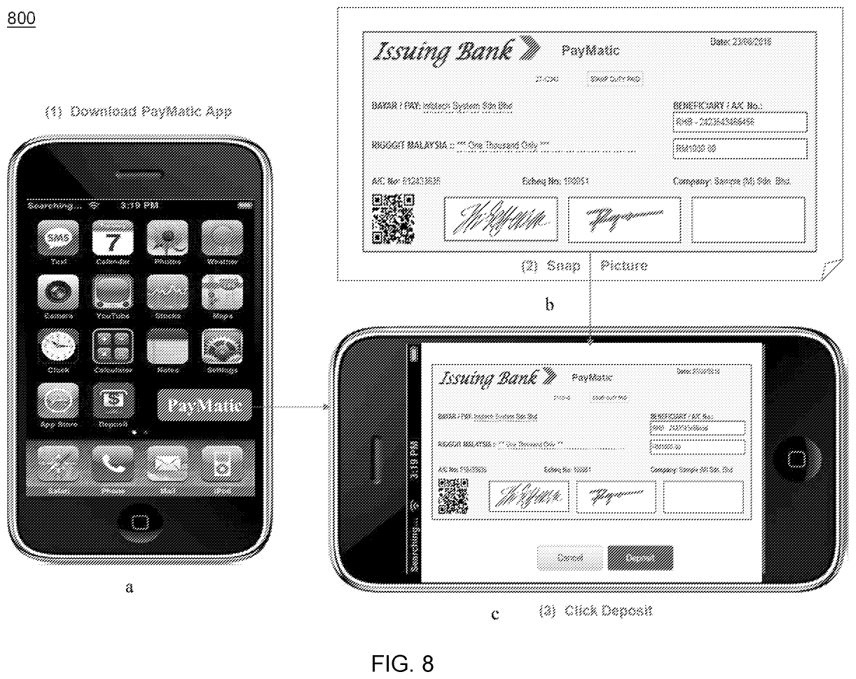

According to an embodiment of the present invention, the deposit module (204) is configured to enable the beneficiary of the digital cheque to deposit the digital cheque using his/her mobile phone (104), as shown in FIG. 8. In an embodiment, the beneficiary may use his/her mobile phone (104) and may open the cheque deposit system application installed on his/her mobile phone such as ‘Paymatic’ shown in FIG. 8(a). Further, the beneficiary of the cheque may take a photo of the printed cheque or scan the digital cheque using the cheque depositing system application, as shown in FIG. 8(b). Further, the beneficiary of the cheque may deposit the cheque on the cheque clearing system application (such as ‘Paymatic’) installed on his/her mobile phone (104) using the deposit module (204), as shown in FIG. 8(c). Further, in another embodiment, the printed cheque may be a cash cheque that may be encashed by the beneficiary at a branch of the bank. Further, according to an embodiment of the present invention, the cheque may be deposited by anyone (beneficiary as well as non-beneficiary) who has downloaded the “Paymatic” app in their mobile phone. Those skilled in the art will appreciate that the deposit module (204) facilitates deposit of the cheque by anyone, and does not restrict only cheque beneficiary to deposit the cheque.

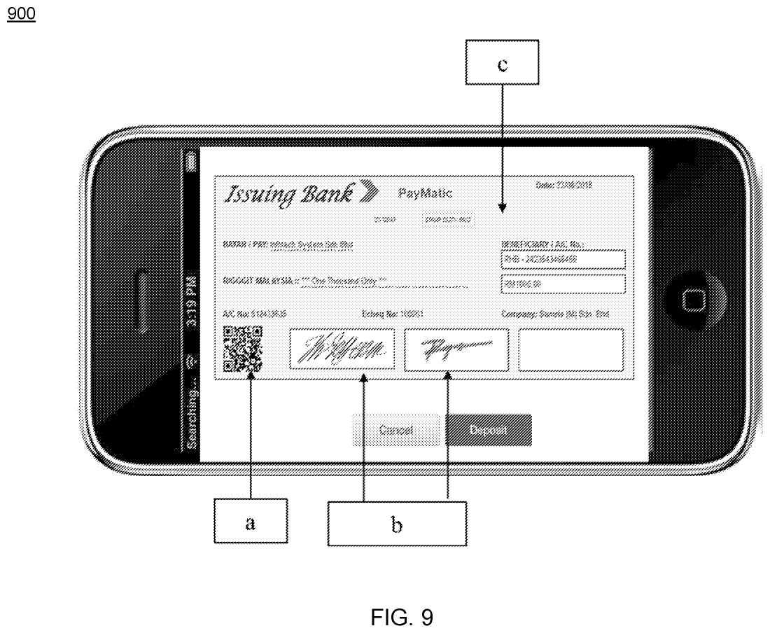

Further, according to an embodiment of the present invention, the processing module (206) is configured to receive the digital cheque from a beneficiary mobile phone (104), and process the digital cheque to retrieve detailed information about the cheque. In an embodiment, the processing module (206) is configured to process the QR code to retrieve detailed information about the cheque, as shown in FIG. 9(A). Further, the processing module (206) is configured to process the signature provided on the cheque, as shown in FIG. 9(B). Further, the processing module (206) is configured to process other information provided on the digital cheque, as shown in FIG. 9(C).

According to an embodiment of the present invention, the verification module (208) is configured to verify the retrieved information from the digital cheque with corresponding information stored by the bank server (108). In an embodiment, the verification module (208) may match the signature (manual or digital) provided on the cheque with signature of the bank's customer stored in database of the bank server or verify the digital signature via verification system.

Further, the verification module (208) may verify information received from QR code with information stored on the bank server. In an embodiment, the verification module (208) may verify beneficiary name, beneficiary bank, beneficiary a/c no, date, amount, payment description, and customer signature in real-time to speed up the cheque clearing process. In another embodiment, the verification module (208) may send a confirmation link or one time password (OTP) to the customer of the bank to confirm about the ordered digital cheque. Those skilled in the art will appreciate that such process will provide additional security to the financial transaction, and will provide clearing up of the cheque in real time.

According to an embodiment of the present invention, the credit module (210) is configured to credit amount of the digital cheque in the beneficiary account based on the successful verification. In an embodiment, the cheque clearing system (102) is connected with a bank server of the beneficiary, and can access account number of the beneficiary. Those skilled in the art will appreciate that bank server of the beneficiary may same or different than bank server of the customer issuing the cheque.

In an embodiment, in case the customer signature and other information provided on the cheque, matches with the customer signature and other information stored on the bank server (108), the credit module (210) may credit the account of the beneficiary with the amount of the digital cheque. In case, signature and other information do not match with signature and information stored on the bank server (108), the credit module (210) is configured to alert the customer and the bank about the invalid transaction tried by the beneficiary.

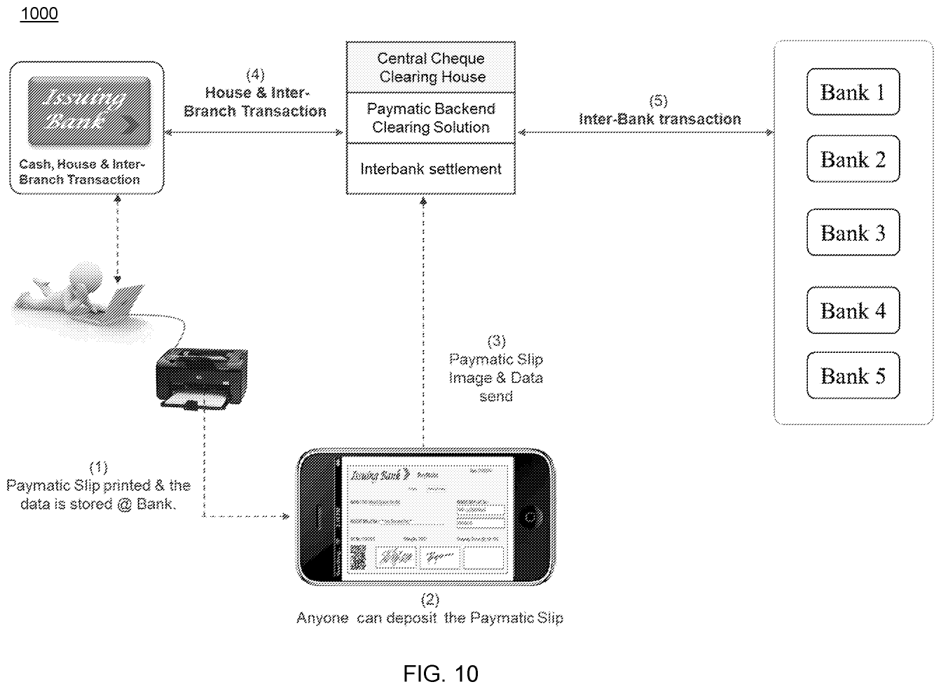

FIG. 10 shows a process flow (1000) about printing of the digital cheque by the customer from banks web portal/banks financial portal/online banking or client server application. The customer may provide details of beneficiary/payee' name, beneficiary bank, beneficiary a/c no., amount payable, and reason for payment (optional). In an embodiment, at first step, when the customer clicks on print cheque button, the digital cheque may be printed on the blank paper at customer premises by a printer attached to the computer. Further, at the first step, data of printed digital cheque may be stored automatically at bank server (108) for verification when the digital cheque is presented for payment by the beneficiary/payee. Further, in an embodiment, whenever the digital cheque is printed on the blank paper, it prints a quick response code (QR code), whereby all the digital cheque information will be converted, embedded or stored in QR code.

In the second step, anyone (beneficiary of the cheque or any other person) can deposit the cheque. In an embodiment, the payee may scan, take a picture or photo of the digital cheque and click ‘deposit button’ to deposit the digital cheque via his/her smart mobile phone (104) application by clicking on ‘Paymatic Application’. In the third step, image and data of the digital cheque may be sent to the bank's server (108).

After the digital Cheque is deposited to bank's server, the quick response (QR) code may be converted to data for processing during fourth step. In an embodiment, during fourth step, the digital cheque data and image may be stored in the respective database table at the cheque clearing system, and the digital cheque information may be verified automatically against the data that is captured during cheque issued. Further, in an embodiment, manual verification may be done for the signature and bank balance, if the cheque clearing system (102) is not integrated with a core banking system (CBS) of the bank server (108). Further, at fifth step, in case of inter-bank cheque, inter-bank transaction may be conducted.

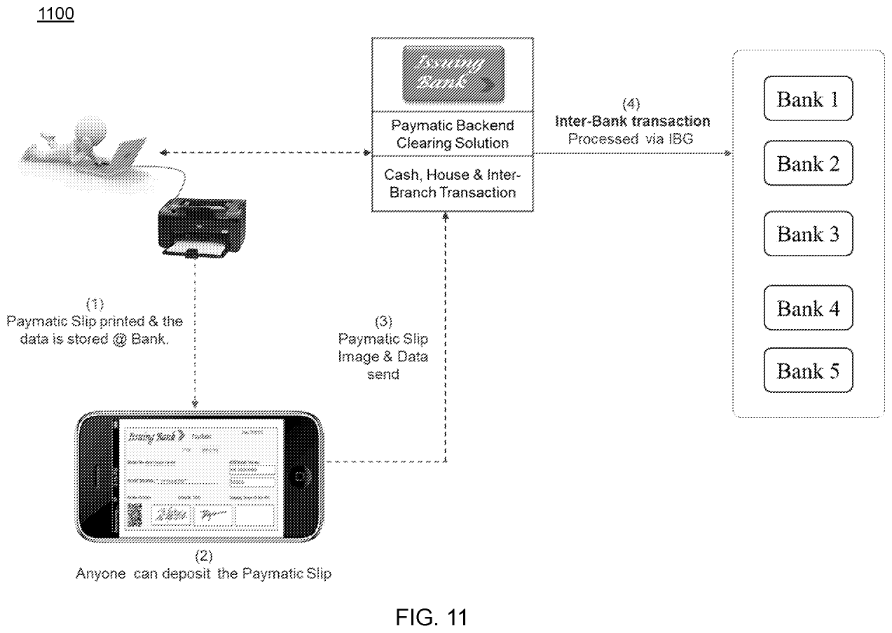

In an embodiment, the digital cheque may be any type of cheque, for example, cash cheque, printed cheque or an electronic cheque. If the cheque is a cash cheque, inter-branch or house cheque, the transaction may be completed within the bank, as shown in process flow (1100) of FIG. 11. At first step, the customer of the bank may login at web portal of the bank and may print the cheque using the digital cheque module link given on home page. Further, the cheque may be printed using a printer attached to the customer's personal computer.

At second step, the beneficiary of the cheque may deposit the cheque using his/her smart phone (104) having the cheque depositing system application. At the third step, the details of the cheque may be sent to the cheque clearing system (102). Further, if it is inter-bank cheque, at fourth step, the transaction may be completed via interbank fund transfer system (like IBG) or online banking transaction. Further, the customer of the bank who issued the cheque may be informed about the transaction. In another embodiment, the customer of the bank who issued the cheque may be required to confirm the transaction using one time password (OTP). Further, the amount of the cheque is credited in the beneficiary account in case of successful verification.

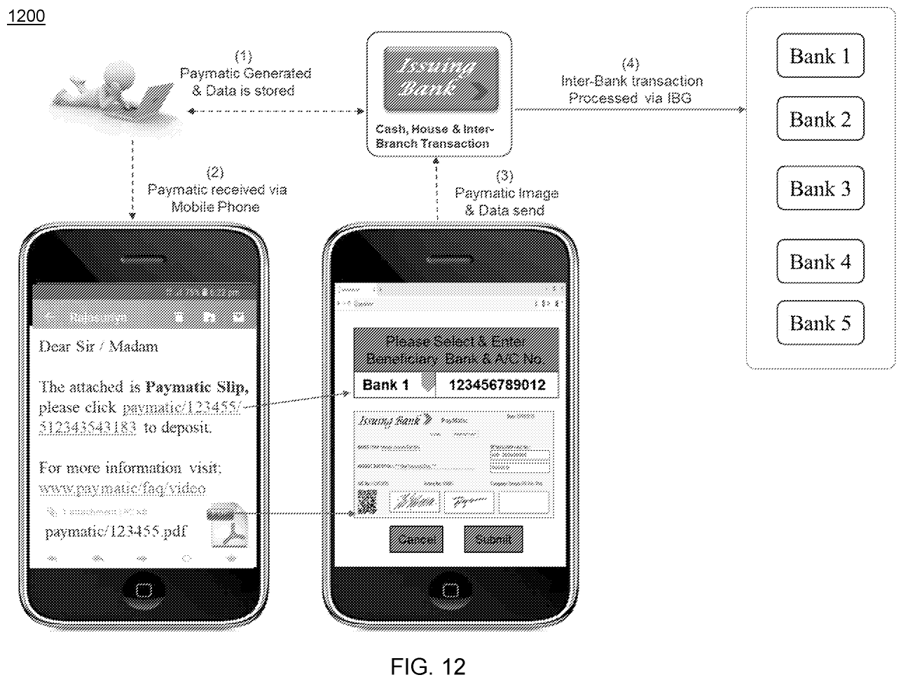

In yet another embodiment, if the cheque is digital cheque, as shown in process flow (1200) of FIG. 12. At first step, the customer of the bank may login on web portal of the bank and may give order to issue a digital cheque to the bank server. Further, a copy of the digital cheque may be generated at the personal computer of the customer, and the customer may be given option to mail/share the copy of the digital cheque with a desired beneficiary of the cheque. At second step, the beneficiary of the cheque may deposit the digital cheque using cheque depositing system application installed on his/her smart phone (104). A copy of the digital cheque may be saved on the cheque clearing system application installed on beneficiary smart phone (104).

At third step, the cheque clearing system (102) may retrieve data of the digital cheque using the QR code and may send the data to the bank server (108) for verification. In an embodiment, the bank server may receive the data of the cheque may send to the customer who issued the cheque for confirmation. After confirmation by the customer, the bank server may start processing and verification of the cheque for crediting the amount of the cheque in the beneficiary account. Further, if it is inter-bank cheque, in the fourth step, the transaction may be completed via interbank fund transfer system (like IBG) or online banking transaction. In an embodiment, the whole cheque clearing process may be completed in real time by the cheque clearing system (102). Further, whole cheque clearing process may be done with minimal or no human interference.

The cheque clearing system (102) and methods performed by the cheque clearing system (102) advantageously provides real time settlement of the cheques, instead of taking 2-3 business days of conventional methods. Further, the cheque clearing system provides additional security and prohibits usage of the fraudulent cheques by eliminating human error in the cheque clearing process. Further, the cheque clearing system (102) saves a lot of time of the beneficiary as he does not need to go to the cheque depositing machine (CDM) or bank branch for depositing and clearing the cheque. Further, the cheque clearing system (102) facilitates whole cheque clearing process with minimal or no human interference.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A cheque clearing system (102) for enabling customers of a bank to issue digital cheques from bank server (108) using their computer (105), and for enabling beneficiary of cheques to deposit the digital cheques using their mobile phones (104), the cheque clearing system (102) comprising a processor (110) and a memory (112), the memory (112) storing:
a digital cheque module (202) configured to enable a customer of a bank to issue a digital cheque from a bank server (108) using the computer (105);
a deposit module (204) configured to enable a beneficiary of the cheque to deposit the digital cheque using his/her mobile phone (104);
a processing module (206) configured to receive the digital cheque from the beneficiary mobile phone (104), and process the digital cheque to retrieve information about the cheque; and
a credit module (210) configured to credit amount of the digital cheque in beneficiary account, based on the processing and successful verification.

2. The cheque clearing system (102) of claim 1, wherein the digital cheque module (202) is further configured to provide the customer of the bank a link on the home page of the customer account, to print the digital cheque.

3. The cheque clearing system (102) of claim 1, wherein the cheque comprising a printed cheque or a digital cheque.

4. The cheque clearing system (102) of claim 1, wherein the digital cheque includes beneficiary name, beneficiary bank, beneficiary a/c no., date, amount, payment description, signature, and a quick response code (QR code).

5. The cheque clearing system (102) of claim 4, wherein the processing module (206) is configured to process the quick response code (QR code) to retrieve information about the cheque.

6. The cheque clearing system (102) of claim 4, wherein the processing module (206) is configured to process the signature provided on the digital cheque.

7. The cheque clearing system (102) of claim 1, further comprising a verification module (208) configured to verify the retrieved information from the digital cheque with information stored on the bank server (108).

8. The cheque clearing system (102) of claim 7, wherein the verification module (208) is configured to match the manual or digital signature provided on the printed cheque with signature of the bank's customer stored on the bank server (108).

9. The cheque clearing system (102) of claim 1, wherein the credit module (210) is further configured to alert the customer and the bank, about valid and invalid transaction performed by the beneficiary.

10. A computer-implemented method for enabling customers of a bank to issue digital cheques from bank server (108) using their computer (105), and for enabling beneficiary of cheques to deposit the digital cheques using their mobile phones (104), the computer-implemented method comprising:
enabling a customer of a bank to issue a digital cheque from a bank server (108) using the computer (105);
enabling a beneficiary of the cheque to deposit the cheque using his/her mobile phone (104);
receiving the digital cheque from a beneficiary mobile phone (104), and processing the digital cheque to retrieve information; and
crediting amount of the digital cheque in beneficiary account based on the processing and successful verification.

11. The computer-implemented method of claim 10, wherein the digital cheque includes beneficiary name, beneficiary name, beneficiary a/c no., date, amount, payment description, signature, and a quick response code (QR code).

12. The computer-implemented method of claim 11, wherein the processing comprises processing the quick response code (QR code) to retrieve information about the cheque.

13. The computer-implemented method of claim 10, further comprising verifying the retrieved information from the digital cheque with information stored on the bank server (108).

14. The computer-implemented method of claim 13, wherein the verifying comprises matching the manual or digital signature provided on the printed cheque with signature of the bank's customer stored on the bank server (108).

15. The computer-implemented method of claim 10, wherein the cheque comprising a printed cheque or a digital cheque.
